(19) United States
(12) Patent Application Publication
(10) Pub. No.: US 2024/0187267 A1
(43) Pub. Date: Jun. 6, 2024

(54) METHOD, USER TERMINAL, AND SERVER FOR DISPLAYING CHAT ROOM BASED ON LOCATION INFORMATION

(71) Applicant: KAKAO CORP., Jeju-si, Jeju-do (KR)

(72) Inventor: Rae Eun LEE, Seongnam-si (KR)

(21) Appl. No.: 18/520,236

(22) Filed: Nov. 27, 2023

(30) Foreign Application Priority Data
Dec. 1, 2022 (KR) 10-2022-0165346

(51) Int. Cl. H04L 12/18; H04L 67/52

(52) U.S. Cl. CPC H04L 12/1813; H04L 67/52

(57) ABSTRACT

Proposed is a method for a user terminal to display a chat room based on location information. The method may include displaying a map for a specific geographic area. The method may also include displaying a first object corresponding to a first chat room in association with the map, the first chat room being associated with first location information, and the first location information and the specific geographic area satisfying a predetermined condition. The method may further include receiving an interaction on the first object and displaying information regarding the first chat room.

### CROSS-REFERENCE TO RELATED APPLICATION

This application claims priority to and the benefit of Korean Patent Application No. 10-2022-0165346 filed on Dec. 1, 2022, the disclosure of which is incorporated herein by reference in its entirety.

### BACKGROUND

### Technical Field

The present disclosure relates to a method for displaying a chat room in relation to a map based on location information and providing an interface for participating in the chat room.

### Description of Related Technology

With the advancement of wireless communication technology and the widespread use of smartphones, messenger services that enable people to communicate with others without limitations of time and location have become increasingly accessible.

### SUMMARY

One aspect is a method for displaying a chat room in association with a map based on location information and providing an interface for participating in the chat room.

Another aspect is a method for reflecting a user's selected displaying condition when displaying an object corresponding to a chat room on a map.

Another aspect is a method for a user terminal to display a chat room based on location information, the method including: displaying a map for a specific geographic area; displaying a first object corresponding to a first chat room in association with the map, the first chat room being associated with first location information, and the first location information and the specific geographic area satisfying a predetermined condition; receiving an interaction on the first object; and displaying information regarding the first chat room.

The method may further include: prior to displaying the first object, identifying a displaying condition regarding attribute information of the chat room, and the attribute information of the first chat room may satisfy the displaying condition.

The at least one piece of the attribute information may be information regarding a creator of the chat room, and the displaying condition may relate to whether the chat room or a creator of the chat room has a predefined relationship with a user of the user terminal.

The predefined relationship may include any of the following: a relationship of subscribing or bookmarking the chat room, a friendship relationship with the creator within a chat service where the chat room is operated, a relationship based on co-participation in any other chat room operated within the chat service, and a relationship with a conversation history with the creator within the chat service.

The at least one piece of the attribute information may include information regarding at least one of a keyword, a theme, and a chat room type, and in the identifying of the displaying condition, condition information for the at least one of the keyword, the theme, and the chat room type may be acquired.

The first location information may include at least one of location coordinate information, address information, geographic area information, and route information.

The displaying of the first object may include displaying the first object at a location corresponding to the first location information on the map.

In the displaying of the first object, the first object may be displayed according to a predetermined layout in an area distinct from the map.

The displaying of the information regarding the chat room may include: executing a chat application corresponding to the chat service where the chat room is operated; and displaying a chat window of the chat room through the chat application.

The method may further include displaying a second object corresponding to a second chat room in association with the map, the second chat room being associated with second location information, and the second location information and the specific geographic area satisfy a predetermined condition, and the first object and the second object may be distinguished and displayed based on a predefined criterion.

Another aspect is a user terminal for displaying a chat room based on location information, the user terminal including: a memory storing instructions, and a processor configured to execute the instructions to: display a map for a specific geographic area; display a first object corresponding to a first chat room in association with the map, wherein the first chat room is associated with first location information, and the first location information and the specific geographic area satisfy a predetermined condition; receive an interaction on the first object; and display information regarding the first chat room.

Another aspect is a method in which a server displays a chat room based on location information, the method including: acquiring first location information associated with a first chat room from a first user terminal; providing a second user terminal with a map for a specific geographic area; in response to a determination that the first location information and the specific geographic area satisfy a predetermined condition, displaying, in the second user terminal, information regarding a first object corresponding to the first chat room in association with the map; receiving information resulting from an interaction on the first object from the second user terminal; allowing a second user of the second user terminal to participate in the first chat room; and providing the second user terminal with information regarding the first chat room.

The method may further include acquiring an information provision condition regarding other users to receive the information regarding the first chat room through the map from the first user terminal, and the providing of the information regarding the first object may be performed when it is determined that the second user satisfies the information provision condition.

The first location information may relate to geographic area, and a size of the geographic area may be limited based on the information provision condition.

The first location information may relate to geographic area, and the size of the geographic area may be limited based on at least one of the first location information and the attribute information of the first chat room.

Another aspect is a server for displaying a chat room based on location information, the server including: a memory storing instructions, and a processor configured to execute the instructions to: acquire first location information associated with a first chat room from a first user terminal; provide a second user terminal with a map for a specific geographic area; in response to a determination that the first location information and the specific geographic area satisfy a predetermined condition, display, in the second user terminal, information regarding a first object corresponding to the first chat room in association with the map; receive information resulting from an interaction on the first object from the second user terminal; allow a second user of the second user terminal to participate in the first chat room; and provide the second user terminal with information regarding the first chat room.

### BRIEF DESCRIPTION OF THE DRAWINGS

FIG. 1 is a diagram illustrating an example of a network environment according to an embodiment of the present disclosure.

FIG. 2 is a flowchart of the operation of a user terminal according to an embodiment of the present disclosure.

FIG. 3 is a flowchart of the operation of a user terminal according to another embodiment of the present disclosure.

FIG. 4 is a flowchart of the operation of a user terminal according to yet another embodiment of the present disclosure.

FIGS. 5 to 9 are example screens of a process of implementing a method in which a user terminal displays a chat room based on location information according to an embodiment of the present disclosure.

FIG. 10 is a flowchart of the operation of a server according to an embodiment of the present disclosure.

FIG. 11 is a flowchart of the operation of a server according to another embodiment of the present disclosure.

FIG. 12 is a table showing standards for limiting the size of the geographic area when the location information of the chat room is related to geographic area information by the server according to an embodiment of the present disclosure.

### DETAILED DESCRIPTION

Messenger services are provided through the establishment of friendships with other users, and chat rooms are created and operated based on these friendships. Thus, in order to create a chat room with a specific theme, it is necessary to specify the individuals who wish to participate in the chat room and create or invite them to the chat room.

However, in some cases, it may be desirable to create a chat room based on location rather than creating a chat room by specifying the other party. For example, a chat room to find someone to do an activity with in a specific area or a chat room to find someone to engage in activities like used goods trading or group purchasing in a specific area.

Creating chat rooms based on location in such cases poses a challenge as existing messenger services that rely on friend relationships may not adequately provide the desired service. Therefore, in order to solve this problem, there is a need for a method for displaying a chat room or providing information regarding the chat room based on location information.

Hereinafter, embodiments disclosed in the present specification will be described in detail with reference to the attached drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

The singular forms are intended to include the plural forms as well, unless the context clearly indicates otherwise.

In this application, each of the above-described operations may be performed irrespective of the listed order, except for a case where the operations must be performed in the listed order due to a special cause-effect relation of the operations.

It will be further understood that the terms “comprises,” “comprising,” “includes,” “including,” “have” and/or “having” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the attached drawings.

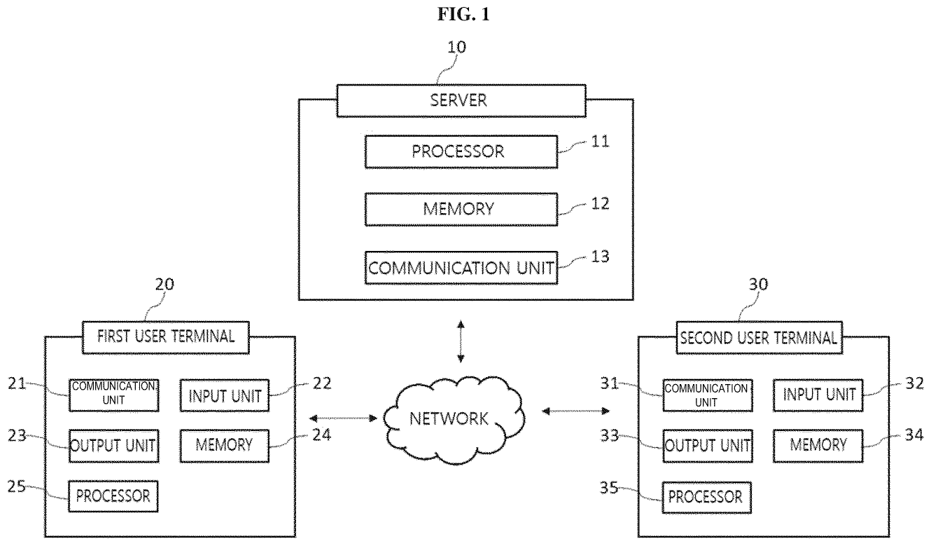

FIG. 1 is a diagram illustrating an example of a network environment according to an embodiment of the present disclosure.

A network environment according to an embodiment of the present disclosure shown in FIG. 1 may include a server 10, a first user terminal 20, and a second user terminal 30.

The server 10 is a device that provides map information and a messenger services to a user terminal 30. The user terminal 30, exemplified by a first user terminal 20 and a second user terminal 30, is a device that uses the map information and messenger service provided by the server 10.

A service for providing map information may be a service in which the server 10 provides map information for a specific area requested by a user. The service for providing map information in the present disclosure is provided to the user terminal 30 through a network, and the map information may be provided based on a current location of the user terminal 30. Specifically, the map information may include not only geographical information of a corresponding area, but also information on points of interest (POIs) such as traffic information, restaurants, and tourist attractions.

The messenger service may be a service that allows a plurality of users to send or receive messages to each other through a platform provided by the server 10. Here, a message may be understood to include all types of transmittable data, including text, photos, videos, voice files, emoticons, and link information.

Communication schemes for a network is not limited. The communication schemes may include not only a communication scheme to utilize a telecommunication network (for example, a mobile communication network, wired Internet, wireless Internet, and a broadcast network), but also a short-range radio communication scheme.

The server 10 may be implemented as a computer device or a plurality of computer devices that provide commands, codes, files, contents, services, and the like. The server 10 may be a server 10 capable of transmitting and receiving information through communication with the user terminal 30 via a network.

The server 10 may include a processor 11, a memory 12, and a communication unit 13.

The processor 11 may control the overall operation of the memory 12 and the communication unit 13 to provide the messenger service to a user terminal.

The memory 12 serves as a storage medium and may store a number of application programs running on the server 10, and data and commands for operation of the server 10. In one embodiment, the memory 12 may store an application related to providing map information and a messenger service.

The memory 12 may be provided in the form of any of various hardware storage devices such as an ROM, an RAM, a flash drive, a hard drive, etc. or may be provided in the form of web storage.

The communication unit 13 may communicate with a user terminal in a wired or wireless manner through a network.

The server 10 of the present disclosure acquires first location information related to a first chat room from the first user terminal 20 and provides a map for a specific geographic area to a second user terminal 30. When it is determined that a first information and the specific geographic area satisfy a predetermined condition, the server 10 provides the second user terminal 30 with information regarding a first object that corresponds to the first chat room in association with the map. Thereafter, the server 10 receives information resulting from an interaction on the first object from the second user terminal 30, allows the second user to participate in the first chat room, and provides the second user terminal 30 with information regarding the first chat room.

Here, in some cases, the server 10 may be divided into a map providing unit and a chat service providing unit. The map providing unit may provide a map and an object corresponding to a chat room in association with the map. The chat service providing unit may acquire information related to the chat room and provide information regarding the chat room. The map providing unit and the chat service providing unit may be operated by the same entity, or in some cases, they may be operated by different business-related entities.

Here, the specific geographic area refers to a geographical extent described by the provided map information. This specific geographic area may be determined based on latitude and longitude coordinates corresponding to a location or on administrative area boundaries. In addition, this specific geographic area may be determined based on a user's current location or an area the user searches for or requests. In some cases, an entire geographic area available to be provided by the server 10 may be determined, and a specific geographic area may be limited to within the entire geographic area.

Here, an object of the chat room (for example, a first object of a first chat room) may be a graphical user interface (GUI) indicating the existence of the chat room on the map. An object of a chat room may be displayed on a map at a location associated with location information of the chat room. The object may correspond to the chat room. Therefore, the user may apply an interaction on the object of the chat room to select the chat room or enter a chat window of the chat room.

Here, the interaction indicates that the user operates an input unit of the user terminal 30 to input information reflecting the user's selection or intention into the user terminal 30. Thus, when the server 10 receives information resulting from an interaction, it implies that the server 10 receives, through the network, information related to the user's interaction on the user terminal 30.

The first user terminal 20 is a device corresponding to a first user in the present disclosure, and the second user terminal 30 is a device corresponding to a second user in the present disclosure. The first and second users are users of the service provided by the server 10, and each of the first and second users may correspond to each user account information registered in the service provided by the server 10. Hereinafter, when the server 10 provides information or service to the first user and the second user, it may imply providing the information or service to the first user terminal 20 and the second user terminal 30 based on user account information corresponding to each of the first user and the second user.

In the present disclosure, although there is no separate distinction in the roles, qualifications, or permissions of the first and second users, the roles of the first and second users are distinguished as follows for clarity in the description. In the present disclosure, it will be described that the first user has the role of creating a chat room and providing location information related to the chat room, and the second user has the role of identifying the chat room through a map and entering the chat room. In the present disclosure, roles, qualifications, or permissions are not limited based on the user or the user terminal 30. That is, the first user may also perform the roles of the second user, and vice versa.

The first user terminal 20 is a device that requests the server 10 to create a chat room and provides location information related to the chat room. The first user terminal 20 may include a communication unit 21, an input unit 22, an output unit 23, a memory 24, and a processor 25.

The communication unit 21 may communicate with the server 10 or other terminals in a wired or wireless manner.

The input unit 22 may receive various information through the user's manipulation and input actions. Such input units may include a touch screen module, a keyboard, a mouse, a button, a camera, a stylus, and a microphone.

The first user terminal 20 may receive a user's interaction through the input unit 22. The interaction indicates that the user operates the input unit 22 to input information that reflecting the user's selection or intention into the first user terminal 20. For example, the interaction may include touching on a touchscreen, clicking with a mouse, typing on a keyboard, providing voice input through a microphone, capturing an image using a camera, recognizing movements through a motion sensor, and the like.

The output unit 23 may output various information. The output unit 23 may be a display device, a speaker, a vibration generator, a tactile generator, etc. In some cases, the output unit 23 may be a device (e.g., Bluetooth earphone) that is connected to a user terminal through wired or wireless communication (e.g., short-range radio communication such as Bluetooth) to receive and output a signal.

The memory 24 serves as a storage medium and may store a plurality of application programs running on a user terminal, and data and instructions for operating the first user terminal 20. This memory may be provided in the form of any of various hardware storage devices such as an ROM, an RAM, a flash drive, a hard drive, etc. or may be provided in the form of web storage. In one embodiment, an application associated with a messenger service (hereinafter referred to as “application”) may be stored in the memory 24.

The processor 25 may execute an application by controlling the overall operation of the communication unit 21, the input unit 22, the output unit 23, and the memory 24.

The second user terminal 30 is a device that is the same as or similar to the first user terminal 20. The second user terminal 30 is a device that receives map information from the server 10 and displays the map information along with an object corresponding to the chat room in association with the map.

The second user terminal 30 may include a communication unit 31, an input unit 32, an output unit 33, a memory 34, and a processor 35. Each component included in the second user terminal 30 performs essentially the same function as each corresponding component included in the first user terminal 20.

The second user terminal 30 displays a map for a specific geographic area and displays a first object corresponding to the first chat room in association with the map. Here, the first chat room is associated with first location information, and the first location information and specific geographic area satisfy a predetermined condition. Then, the second user terminal 30 receives an interaction on the first object, enters the first chat room, and displays a chat window of the first chat room.

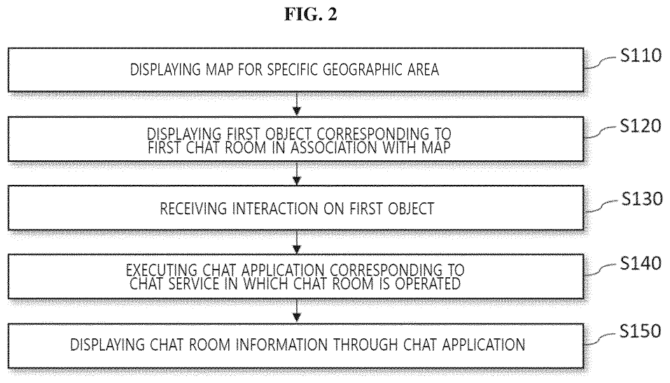

Hereinafter, with reference to FIGS. 2 to 9, a method in which the second user terminal 30 displays a chat room based on location information according to an embodiment of the present disclosure will be described. In the following description, the second user terminal 30 will be referred to as the user terminal 30 for convenience of explanation.

Operations described below may be performed regardless of the listed order, except in cases where they must be performed in the listed order due to a special cause-effect relation of the operations. Hereinafter, for the convenience of explanation, it is assumed that the operations are explained in the order they are listed.

FIG. 2 is a flowchart of the operation of the user terminal 30 according to an embodiment of the present disclosure.

In operation S110, the user terminal 30 displays a map for a specific geographic area.

The user terminal 30 may receive map information for the specific geographic area from the server 10. The user terminal 30 may display the map information, received from the server 10, through an application with a map display function installed in the user terminal 30 or through a web browser.

The map information may be limited to a specific geographic area. In general, the user terminal 30 has a display of limited size and displays a map on such a display. Thus, the user terminal 30 displays a map limited to a specific geographic area that can be displayed on the display.

In operation S120, the user terminal 30 displays a first object corresponding to a first chat room in association with the map.

Specifically, when the first chat room is associated with first location information and when the first location information and the specific geographic area satisfy the predetermined condition, the user terminal 30 displays the first object corresponding to the first chat room.

The first chat room is associated with first location information. The first location information may be any one of attributes of the first chat room. The first location information associated with the first chat room may be information determined by the user terminal 20, which has created the first chat room, and provided by the user terminal 20 to the server 10.

This first location information may be one of various types related to location. For example, the first location information may be at least one of the following: location coordinate information based on latitude and longitude, address information, geographic area information, and route information.

For example, when the first location information is location coordinate information, the first location information may be set in the form of latitude and longitude coordinates, such as (37.3957122, 127.1105181). In addition, when the first location information is geographic area information, the first location information may be set to geographic area within a 2.0 km radius from the center (37.3957122, 127.1105181).

The first object may be displayed when the first location information and the specific geographic area satisfy the predetermined condition. The predetermined condition may be set in various ways. For example, when the first location information is location coordinates, the predetermined condition may relate to whether the first location information is included within the specific geographic area. In addition, in some cases, satisfying the predetermined condition may involve not only the first location information being included within the specific geographic area, but also the first location information being included within a predetermined adjacent range. In addition, when the first location information is geographic area, the predetermined condition may relate to how much the geographic area corresponding to the first location information overlaps with the specific geographic area.

The first object corresponds to the first chat room and may show relevant information of the first chat room, such as characteristics or attributes of the first chat room. For example, the first object may show at least one of the following: the creator of the first chat room, the type of the first chat room, and the theme of the first chat room. In some cases, when the first object includes information regarding the creator of the first chat room, the creator of the first chat room may be a profile photo of the creator registered in the chat service.

In some cases, the first object corresponds to the first chat room and may not show relevant information of the first chat room, such as characteristics and attributes, but only include simple indicators, such as keywords. In this case, when the user applies an interaction on the first object, the relevant information of the first chat room corresponding to the first object may be additionally displayed.

In operation S120, the first object may be displayed simultaneously with the map in operation S110. In some cases, the first object may be displayed at a separate display request from the user.

For example, the map may display interfaces that allow a user to select points of interests (POIs). Any object corresponding to a chat room is considered as a POI and may be displayed in any one of the above-described interfaces. Specifically, the interfaces may include, for example, restaurants, cafes, bakeries, etc., and these interfaces may include an interface indicating “Nearby Chat Room” or the like.

For example, when the user applies an interaction to select an interface indicating “Restaurants” among the interfaces, POIs corresponding to the characteristic of “Restaurants” may be displayed on the map. In addition, when the user applies an interaction to select an interface displaying “Nearby Chat Rooms” among the interfaces, an object corresponding to a chat room that satisfies a condition for location information may be displayed on the map.

In operation S130, the user terminal 30 receives an interaction on the first object.

The interaction on the first object may include an interaction divided into multiple steps. For example, when a primary interaction on the first object is input, detailed information and additional information of the first chat room corresponding to the first object may be displayed. The additional information may include an interface such as “Join Chat Room.” A secondary interaction on the interface such as “Join Chat Room” may be additionally input.

In operation S140, the user terminal 30 executes a chat application corresponding to the chat service in which the chat room is operated.

The chat rooms may be operated in various ways. For example, the chat room may be operated by a chat application. In some cases, the chat room may be operated based on a web browser. In addition, in some cases, the chat service may be supported in a map application that provides map information.

Hereinafter, it is assumed that a chat room is operated by a chat application corresponding to a chat service. However, the present disclosure does not exclude other ways of operating a chat room.

If preceding operations S110, S120, and S130 are performed in a map display application, operation S140 following operation S130 may be performed by transitioning from the map display application to a chat application.

If the chat application is installed on the user terminal 30, the chat application is executed. If the chat application is not installed, the user terminal 30 may be directed to an installation path of the chat application.

If the user is logged in to the chat application on the user terminal 30 with a user account, next operation 150 may be performed immediately. If the user is not logged in, a page instructing the user to log in may be displayed.

In operation S150, the user terminal 30 displays information regarding the chat room through a chat application.

In operation S140, when the chat application is executed and when logging in with the user account is completed, the user enters the first chat room. If a separate permission or setting is required for the user to enter the first chat room, guidance for obtaining or inputting the permission or setting may be displayed.

Here, the information regarding the chat room may be a chat window of the chat room. The chat window refers to a chat window through which the user can enter a first chat room to receive or send messages. The chat window may include a message display area for displaying messages and a message input area for entering messages. In some cases, it is also possible that information associated with the chat room, rather than information regarding the chat window of the chat room, is provided in operation S150.

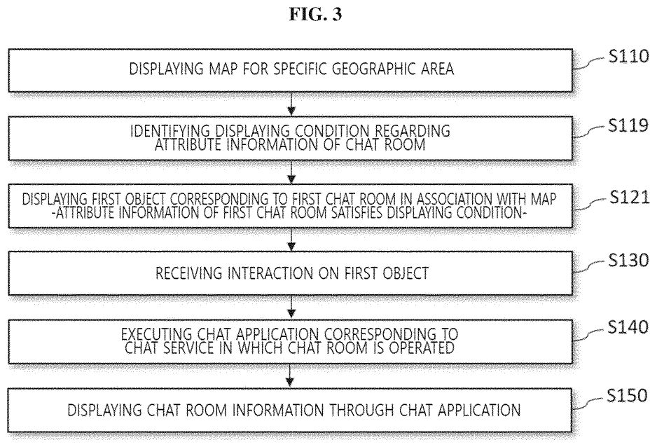

FIG. 3 is a flowchart of the operation of the user terminal 30 according to another embodiment of the present disclosure.

Among the operations described in the flowchart of FIG. 3, only operation S119 and operation S121 differ from FIG. 2, while other operations are substantially the same as those described above with reference to FIG. 2. For convenience of explanation, when explaining the operation of the user terminal 30 with reference to FIG. 3, the focus will be on the differences from what is described with reference to FIG. 2.

In operation S119, the user terminal 30 identifies a displaying condition regarding attribute information of a chat room. Preferably, operation S119 is performed before an object corresponding to the chat room is displayed on the user terminal 30.

In some cases, there may be a plurality of chat rooms that satisfy a condition for location information for a specific geographic area, and a plurality of objects corresponding to the chat rooms may be displayed in association with the map. In this case, too many objects may be displayed, or two or more objects may overlap each other. In addition, the user may prefer that only an object corresponding to a chat room that satisfies a displaying condition desired by the user is displayed in association with the map. In this case, in association with the map, the user terminal 30 may display only the object corresponding to the chat room that satisfies the displaying condition.

A displaying condition regarding attribute information of a chat room may be set based on various criteria. Specifically, the displaying condition may relate to whether the creator of a chat room has a predefined relationship with the user of the user terminal 30. Here, the predefined relationship may be, for example, one of the following: a friendship relationship within the chat service where the chat room is operated, a relationship based on co-participation in any other chat room operated within the chat service, or a relationship based on conversation history within the chat service.

For example, the user may input setting information to the user terminal 30, so that only objects corresponding to chat rooms created by the user's friends in the chat service are displayed. In addition, for example, the user may input setting information so that objects corresponding to all chat rooms are displayed on the user terminal 30, regardless of the relationship between the creator of a separate chat room and the user of the user terminal 30. In some cases, the setting information may not be input by the user but rather provided by the service operator.

In addition, the displaying condition may relate to whether the chat room itself has a predefined relationship with the user of the user terminal 30. The user may establish a relationship with a chat room through actions like subscribing, joining, bookmarking, or adding to a list. For example, if a chat room used for advertising or promotions (e.g., KakaoTalk Channel (registered trademark)), the user may add the chat room to the user's chat room list. In this case, the chat room may have the predefined relationship with the user.

In operation S121, the user terminal 30 displays a first object corresponding to a first chat room in association with a map. Here, the first chat room corresponding to the first object is limited to a case where attribute information of the first chat room satisfies the displaying condition. If there is another chat room that satisfies both the predetermined condition for location information and the displaying condition, an object corresponding to the chat room may also be displayed.

After operation S121, operation S119 may be performed again to change the displaying condition. In this case, operation S121 may be performed again, and an object for a chat room that satisfies the displaying condition may be displayed.

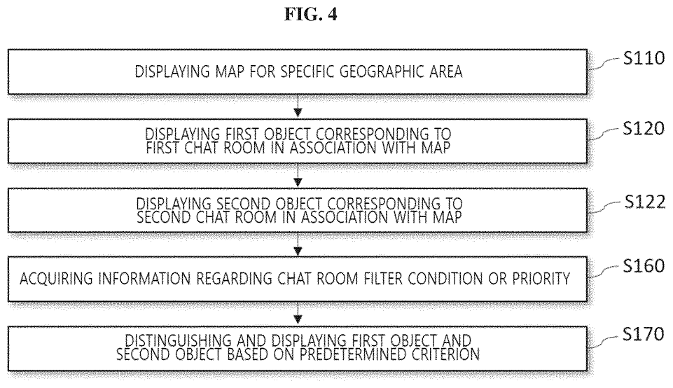

FIG. 4 is a flowchart of the operation of the user terminal 30 according to yet another embodiment of the present disclosure.

Among the operations described in the flowchart of FIG. 4, only operation S122, S160, and S170 differ from FIG. 2, while other operations are substantially the same as those described above with reference to FIG. 2. For convenience of explanation, when explaining the operation of the user terminal 30 with reference to FIG. 4, the focus will be on the differences from what is described with reference to FIG. 2.

In operation S122, the user terminal 30 displays a second object corresponding to a second chat room in association with the map.

In FIG. 4, it is described that operations S120 and S122 are performed sequentially. In some cases, however, operations S120 and S122 may also be performed simultaneously.

As operations S120 and S122 are performed, a plurality of objects is displayed in association with the map. The present disclosure involves displaying two or more objects in association with a map.

As such, when a plurality of objects is displayed in association with a map for a specific geographic area, too many objects may be displayed or two or more objects may overlap each other. In addition, the user may prefer that only an object corresponding to a chat room that satisfies a displaying condition desired by the user is displayed in association with the map. For this purpose, operations S160 and S170 may be performed.

In operation S160, the user terminal 30 acquire information regarding a chat room filter condition or priority.

The chat room filter condition may be set by various information related to the chat room. Specifically, the chat room filter condition may be set by chat room creator, eligibility for participation, chat room type, keywords, theme, and available participation period, and the like.

For example, the chat room filter condition may be set by chat room type. In the present disclosure, a type of a chat room displayed based on location information may include, for example, a chat room type related to group purchasing or selling, a chat room type related to finding friends to engage in activities together, or a chat room type related to advertisements or promotions (e.g., KakaoTalk Channels, registered trademark), and the like. The user terminal 30 may provide a filter selection function that allows the user to select at least one of a plurality of chat room types in operation S160.

Priorities of chat rooms may be set based on various information related to the chat room. For example, the priorities of the chat rooms may be set based on a relationship with the creators of the chat rooms, available participation periods, or distances from the user's current location.

For instance, the priorities of the chat rooms may be set based on the distances of from the user's current location. In this case, in next operation S170, a plurality of chat rooms may be displayed in order of proximity from the user's current location.

In operation S170, the user terminal 30 distinguishes and displays the first object and the second object based on a predefined criterion.

Here, the predefined criterion may be selectively displaying objects that satisfy some filter conditions, or arranging and displaying objects based on a predefined order according to priorities.

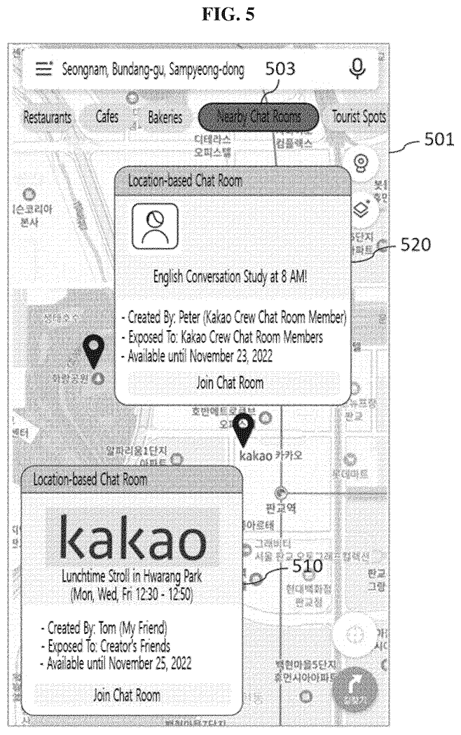

Hereinafter, an example screen of a process in which the user terminal 30 performs a method for displaying a chat room based on location information according to an embodiment of the present disclosure will be described with reference to FIGS. 5 to 9.

FIG. 5 is an example screen showing objects corresponding to a map and a chat room in the user terminal 30 according to an embodiment of the present disclosure. FIG. 5 shows a screen showing a result of operation S120 of FIG. 2.

Referring to FIG. 5, a map 501 for a specific geographic area is displayed on the display of the user terminal 30. In addition, a plurality of interfaces is displayed on the map 501 to select indicators of POIs. Among the plurality of interfaces, an interface 503 marked as “Nearby Chat Rooms” is selected.

As a result of selecting the interface 503, a first object 510 corresponding to a first chat room and a second object 520 corresponding to a second chat room are displayed in association with the map. Each of the first object 510 and the second object 520 may be displayed at a location corresponding to location information related to a corresponding one of the respective chat rooms.

Each of the first object 510 and the second object 520 may display information related to attributes of a corresponding one of the respective chat rooms. For example, the first object may show the main theme, creator, target viewers, available dates for participation, and the “Join Chat Room” interface, and the like.

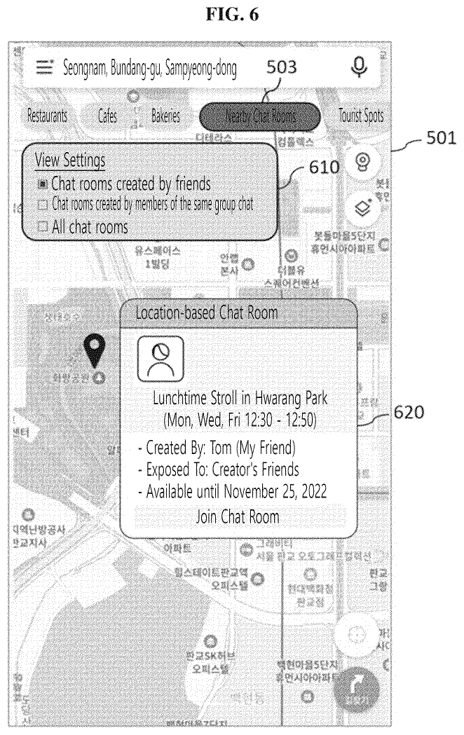

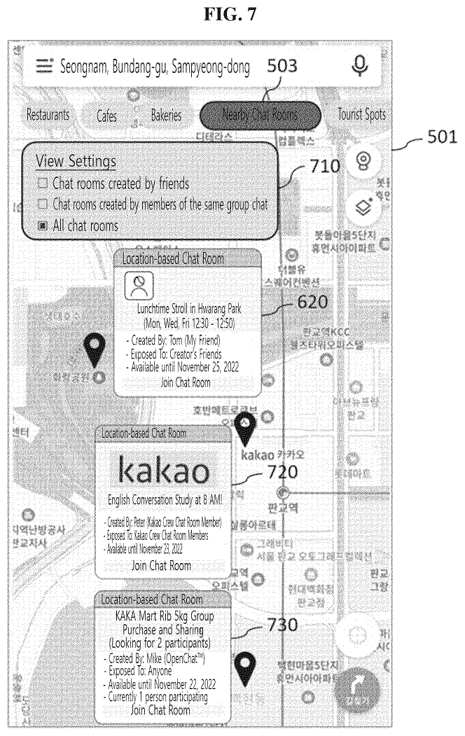

FIGS. 6 and 7 are example screens on which the map 501 and objects corresponding to chat rooms are displayed in the user terminal 30 according to another embodiment of the present disclosure. FIGS. 6 and 7 show screens as a result of operation S121 of FIG. 3.

The user terminal 30 may identify displaying conditions 610 and 710 regarding attribute information of a chat room. Specifically, the displaying conditions 610 and 710 may relate to whether a chat room creator has a predefined relationship with the user of the user terminal 30.

Referring to FIG. 6, a displaying condition is selected, as indicated by 610, when the chat room creator is a friend of the user in the chat service. Accordingly, in FIG. 6, an object 620 corresponding to a chat room created by a friend of the user in the chat service is displayed.

Referring to FIG. 7, a displaying condition is selected, as indicated by 710, to display all created chat rooms regardless of whether the creators of the chat rooms have any predefined relationship with the user. Accordingly, in FIG. 7, in addition to the object 620 shown in FIG. 6, objects 720 and 730 corresponding to all chat rooms, of which associated location information satisfies a condition for a specific geographic area, may be displayed.

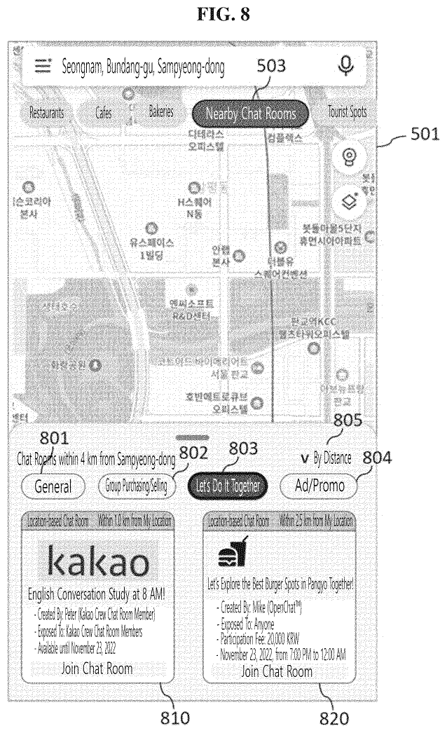

FIG. 8 is an example screen on which the map 501 and objects corresponding chat rooms are displayed in the user terminal 30 according to yet another embodiment of the present disclosure. FIG. 8 shows a screen as a result of operation S170 of FIG. 4.

Referring to FIG. 8, a chat room filter condition may be set by chat room type. Specifically, in FIG. 8, there may be provided chat room types including General 801, Group Purchasing/Selling 802, Finding Friends (Let's Do It Together) 803, and Ad/Promo 804. Among these types, the chat room type of Finding Friends (Let's Do It Together) 803 is selected as a filter condition.

As a result, among a plurality of chat rooms, the Finding Friends (Let's Do It Together) 803 is selected, and corresponding objects 810 and 820 are displayed according to a predetermined layout. Specifically, the objects 810 and 820 corresponding to a plurality of chat rooms satisfying the filter condition are displayed sequentially in order of priority by distance 805 from the user's current location.

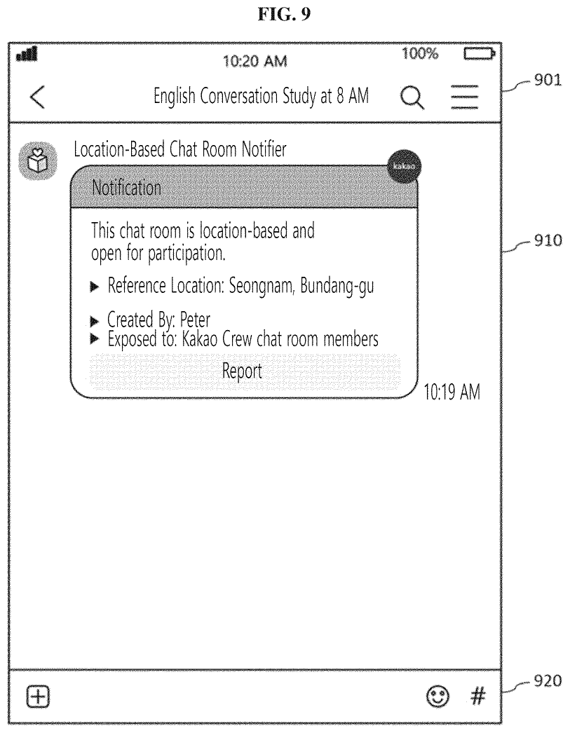

FIG. 9 is an example screen showing a chat window of a chat room in the user terminal 30 according to an embodiment of the present disclosure. FIG. 9 shows a screen as a result of operation S150 of FIG. 2. Specifically, FIG. 9 shows a screen resulting from an interaction on the “Join Chat Room” interface within the object 810 of FIG. 8.

Referring to FIG. 9, a chat window 901 may be displayed through a chat application corresponding to the chat service in which the chat room is operated. The chat window 901 may include a message display area 910 for displaying messages and a message input area 920 for entering messages. Once a user enters a chat room, information regarding the chat room based on location information may be displayed through the message display area of the chat window.

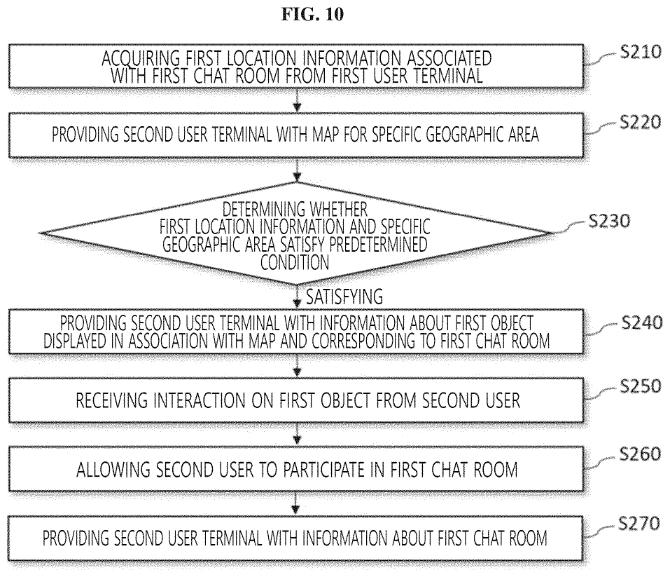

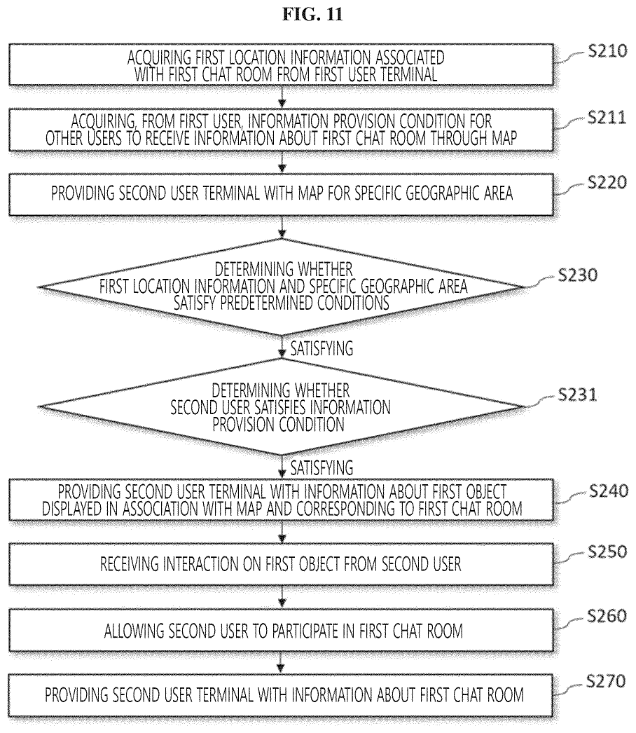

Hereinafter, a method in which the server 10 displays a chat room based on location information according to an embodiment of the present disclosure will be described with reference to FIGS. 10 and 11.

In explaining the method by which the server 10 displays a chat room based on location information with reference to FIGS. 10 and 11, the content that is the same as the method described in FIG. 2 to FIG. 9, where the user terminal 30 displays a chat room based on location information, will be omitted.

FIG. 10 is a flowchart of the operation of the server 10 according to an embodiment of the present disclosure.

In operation S210, the server 10 acquires first location information associated with a first chat room from the first user terminal 20.

The first user terminal 20 may request the server 10 to create the first chat room, and provide the first location information associated with the first chat room. In some cases, the first user terminal 20 may create the first chat room through a request to create a location-based chat room, which is distinct from a general chat room, associated with location information and visible to other users on a map.

The first location information may be one of various location-related types. For example, the first location information may be at least one of the following: location coordinate information based on latitude and longitude, address information, geographic area information, and route information.

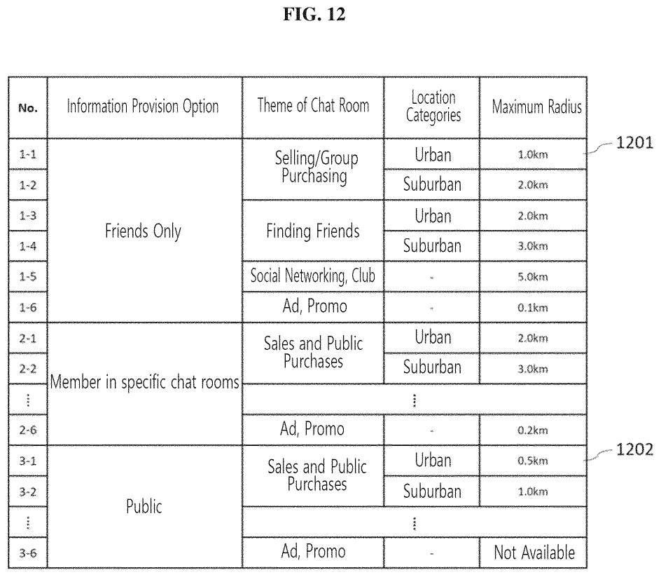

If the first location information relates to geographic area information, the size of geographic area may be limited by various factors. Specifically, the size of geographic area may be limited based on location information, an information provision condition to be described later, and chat room attribute information. This will be explained in more detail with reference to FIG. 12 below.

In operation S220, the server 10 provides a map for a specific geographic area to the second user terminal 30. Operation S220 corresponds to operation S110 described above.

In operation S230, the server 10 determines whether the first location information and the specific geographic area satisfy a predetermined condition.

The server 10 may determine whether the predetermined condition is satisfied based on various criteria. For example, when the first location information is location coordinates, the server 10 may determine whether the predetermined condition is satisfied, by determining whether the first location information falls within a specific geographic area. In some cases, the server 10 may determine that the first location information satisfies the predetermined condition if the first location information falls not just within a specific geographic area but also within a predetermined adjacent range. In addition, when the first location information is geographic area, the server 10 may determine whether the predetermined condition is satisfied, by determining how much the geographic area corresponding to the first location information overlaps with a specific geographic area.

In operation S240, the server 10 provides the second user terminal 30 with information regarding a first object corresponding to the first chat room and displayed in association with the map. Operation S240 is performed when it is determined that the predetermined condition is satisfied in operation S230. Operation S240 corresponds to operation S120 described above.

Although not shown in the drawing, if the predetermined condition is not satisfied in operation S230, the server 10 does not provide the second user terminal 30 with the information regarding the first object corresponding to the first chat room. If the specific geographic area for which a map is provided changes due to a request from the second user terminal 30, operation S230 is performed again. At this point, if the predetermined condition is satisfied, operation S240 is performed.

In operation S250, the server 10 receives an interaction on the first object from the second user terminal 30. Operation S250 corresponds to operation S130 described above.

In operation S260, the server 10 allows a second user to participate in the first chat room. To this end, the server 10 may, in some cases, request actions from the second user terminal 30, such as logging in to the chat application, setting personal information, and the like.

In operation S270, the server 10 provides information regarding the first chat room to the second user terminal 30. Here, the information regarding the first chat room may be a chat window of the first chat room. Operation S270 corresponds to operation S150 described above.

FIG. 11 is a flowchart of the operation of the server 10 according to another embodiment of the present disclosure.

Among the operations described in the flowchart of FIG. 11, only operation S211 and S231 differ from FIG. 10, while other operations are substantially the same as those described above with reference to FIG. 10. For convenience of explanation, when explaining the operation of the server with reference to FIG. 11, the focus will be on the differences from what is described with reference to FIG. 10.

In operation S211, the server 10 acquires, from the first user terminal 20, an information provision condition regarding other users to receive the information regarding the first chat room through the map. The first user may set the information provision condition to determine how the user's created chat room will be exposed to which users through the map.

The information provision condition may be determined based on a relationship with the first user in the chat service. For example, the information provision condition may include cases where the other party has a friendship relationship with the first user in the chat service, where the other party has a relationship with the first user by participating in the same chat room in the chat service, where the other party has a conversation history with the first user in the chat service, and the like. Consequently, it is possible to ensure that the chat room created by the first user is not exposed to an unspecified number of the general public, but only to a limited number of specific individuals according to the user's intention.

In operation S231, the server 10 determines whether the second user satisfies the information provision condition. Subsequent operation S240 is performed only when it is determined that the second user satisfies the information provision condition in operation S231.

Although not shown in the drawing, if the second user does not satisfy the information provision condition in operation S231, the server 10 does not provide the second user 30 with the information regarding the first object corresponding to the first chat room. In the future, if the information provision condition is changed by the first user terminal 20 or the relationship between the first user and the second user changes to thereby allow the second user to satisfy the information provision condition, operation S231 is performed again. In this case, if the predetermined condition is met, operation S240 is performed.

Hereinafter, an example of a process of implementing a method in which the server 10 displays a chat room based on location information according to an embodiment of the present disclosure will be described with reference to FIG. 12.

When location information of a chat room relates to geographic area information, the first user terminal 20 may determine geographic area information by inputting central location and radius information of a range within which a first object corresponding to a first chat room can be displayed. For example, the first user terminal 20 may set the location information of the first chat room to geographic area within a 2.0 km radius centered at (37.3957122, 127.1105181). In this case, the server 10 may compare the geographic area of the chat room with a specific geographic area of a map, provided to the second, and if a predetermined condition is satisfied, the server 10 may enable the second user terminal 30 to display the first object corresponding to the first chat room.

A first user who wishes to expose the chat room to other users may set the geographic area of the chat room excessively wide so as to expose chat room information to a larger number of users. In this case, other users (second user) may experience inconvenience due to the excessive amount of chat room information related to the specific geographic area on the map, making it difficult to identify information regarding chat rooms that other users want. Therefore, in order to solve this problem, it is necessary for the server 10 to limit a maximum size of geographic area when location information of a chat room relates to geographic area information.

FIG. 12 is a table showing criteria that are set by the server 10 according to an embodiment of the present disclosure to limit a maximum size of geographic area when location information of a chat room relates to geographic area information. Referring to FIG. 12, if an information provision condition is “Friends Only,” the theme of the chat room is “Group Purchasing/Selling,” and the location is “Urban,” the first user may set geographic area of the chat room within 1.0 km from the central location.

Referring to FIG. 12, if location information of a chat room relates to geographic area information, the maximum radius of geographic area may be limited by various factors. Specifically, the maximum radius for geographic area may be limited based on an information provision condition, a chat room theme, and a location category.

For example, even in a case where the chat room relates to the same theme of “Group Purchasing/Selling” and is located in the same “Urban” area, a maximum radius 1201 of geographic area is set to 1.0 km if the information provision condition is “Friends Only.” In contrast, if the information provision condition is “Public,” a maximum radius 1202 of geographic area is narrower and set to 0.5 km. This is to limit the chat room from being visible to too many individuals because the chat room is exposed to an unspecified number of the general public.

Also, for example, despite the same information provision condition and the same chat room theme, the maximum radius of geographic area may vary depending on whether the location category is “Urban” or “Suburban.” Specifically, when the location category is “Urban,” the maximum radius of geographic area may be narrower than when the location category is “Suburban.” This is because, in general, when the location is categorized as “Urban,” it is exposed to a larger number of users, and when the location is categorized as “Suburban,” it is exposed to a smaller number of users.

Also, for example, despite the same information provision condition and the same location category, the maximum radius of geographic area may vary depending on a chat room theme. For example, if the chat room theme is “Finding Friends,” the maximum radius of geographic area may be wider than when the chat room theme is “Ad, Promo.” Here, the purpose of the chat room and the usefulness of information may be considered.

In the method for displaying a chat room based on location information according to the present disclosure, it is possible to display a chat room in association with a map based on location information and provide an interface for participation into the chat room.

In addition, in the method for displaying a chat room based on location information according to the present disclosure, it is possible to reflect a user's selected displaying condition when displaying an object corresponding to a chat room in association with a map.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.

What is claimed is:

1. A method for a user terminal to display a chat room based on location information, the method comprising:
displaying a map for a specific geographic area;
displaying a first object corresponding to a first chat room in association with the map, the first chat room being associated with first location information, and the first location information and the specific geographic area satisfying a predetermined condition;
receiving an interaction on the first object; and
displaying information regarding the first chat room.

2. The method of claim 1, further comprising, prior to displaying the first object, identifying a displaying condition regarding attribute information of the chat room,
wherein the attribute information of the first chat room satisfies the displaying condition.

3. The method of claim 2, wherein:
the at least one piece of the attribute information is information regarding a creator of the chat room, and
the displaying condition relates to whether the chat room or a creator of the chat room has a predefined relationship with a user of the user terminal.

4. The method of claim 3, wherein the predefined relationship comprises at least one of: a relationship of subscribing or bookmarking the chat room, a friendship relationship with the creator within a chat service where the chat room is operated, a relationship based on co-participation in any other chat room operated within the chat service, or a relationship with a conversation history with the creator within the chat service.

5. The method of claim 2, wherein:
the at least one piece of the attribute information comprises information regarding at least one of a keyword, a theme, or a chat room type, and
in the identifying of the displaying condition, condition information for the at least one of the keyword, the theme, or the chat room type is acquired.

6. The method of claim 1, wherein the first location information comprises at least one of location coordinate information, address information, geographic area information, or route information.

7. The method of claim 1, wherein the displaying of the first object comprises displaying the first object at a location corresponding to the first location information on the map.

8. The method of claim 1, wherein in the displaying of the first object, the first object is displayed according to a predetermined layout in an area distinct from the map.

9. The method of claim 1, wherein the displaying of the information regarding the chat room comprises:
executing a chat application corresponding to the chat service where the chat room is operated; and
displaying a chat window of the chat room through the chat application.

10. The method of claim 1, further comprising displaying a second object corresponding to a second chat room in association with the map, the second chat room being associated with second location information, and the second location information and the specific geographic area satisfy a predetermined condition,
wherein the first object and the second object are distinguished and displayed based on a predefined criterion.

11. A user terminal for displaying a chat room based on location information, the user terminal comprising:
a memory storing instructions, and
a processor configured to execute the instructions to:
display a map for a specific geographic area;
display a first object corresponding to a first chat room in association with the map, wherein the first chat room is associated with first location information, and the first location information and the specific geographic area satisfy a predetermined condition;
receive an interaction on the first object; and
display information regarding the first chat room.

12. A method for displaying a chat room based on location information in a server, the method comprising:
acquiring first location information associated with a first chat room from a first user terminal;
providing a second user terminal with a map for a specific geographic area;
in response to a determination that the first location information and the specific geographic area satisfy a predetermined condition, displaying, in the second user terminal, information regarding a first object corresponding to the first chat room in association with the map;
receiving information resulting from an interaction on the first object from the second user terminal;
allowing a second user of the second user terminal to participate in the first chat room; and
providing the second user terminal with information regarding the first chat room.

13. The method of claim 12, further comprising acquiring an information provision condition regarding other users to receive the information regarding the first chat room through the map from the first user terminal,
wherein providing the information regarding the first object is performed when it is determined that the second user satisfies the information provision condition.

14. The method of claim 13, wherein:
the first location information relates to geographic area, and
a size of the geographic area is limited based on the information provision condition.

15. The method of claim 12, wherein:
the first location information relates to geographic area, and
the size of the geographic area is limited based on at least one of the first location information and the attribute information of the first chat room.
